(19) United States
(12) Patent Application Publication
(10) Pub. No.: US 2016/0320511 A1
(43) Pub. Date: Nov. 3, 2016

(54) A BOREHOLE SEISMIC TOOL AND METHOD OF SEISMIC SURVEYING

(71) Applicant: SCHLUMBERGER TECHNOLOGY CORPORATION, Sugar land, TX (US)

(72) Inventors: Clement Kostov, Houston, TX (US); Marwan Charara, Moscow (RU)

(73) Assignee: SCHLUMBERGER TECHNOLOGY CORPORATION, Sugarland, TX (US)

(21) Appl. No.: 15/108,232

(22) PCT Filed: Dec. 25, 2013
(86) PCT No.: PCT/RU2013/001168

§ 371 Date: Jun. 24, 2016

(51) Int. Cl. G01V 1/42

(52) U.S. Cl. CPC G01V 1/42; G01V 2001/526

(57) ABSTRACT

The disclosure provides a borehole tool for seismic data collection. The tool comprises a cable to be positioned within a borehole and at least one sensor for measuring seismic signals mounted on the cable. The sensors provide measurements of particle motion (velocity or acceleration) perpendicular to an axis of the borehole. The disclosure also provides methods of seismic surveying, which involves positioning the tool in the borehole, firing a seismic source generating a seismic wave and measuring particle motion associated with the passing seismic wave perpendicular to an axis of the borehole using the at least one sensor for measuring particle motion.

### FIELD OF THE INVENTION

The present disclosure relates to the study of underground formations and structures, more specifically to seismic surveying of subterranean geological formations.

### BACKGROUND

Vertical seismic profiling (VSP) has been one of the more rapidly developing technologies in geophysics in recent years. VSP is the recording of seismic energy from a surface source by sensors in a well or borehole to obtain a high resolution image of the subsurface geology adjacent to the borehole. VSP can provide in situ rock properties, particularly seismic velocity, impedance, anisotropy and attenuation, and it aids in understanding seismic wave propagation.

VSP uses a number of downhole sensors in an array, usually at a regular spacing interval of 50 to 100 feet. Multiple-component receivers, such as triaxial geophones, must be clamped to the borehole wall in order to couple to the wave in all three dimensions. Current borehole seismic acquisition systems are designed to provide a good coupling between the sensor and the formation by means of a clamping device which clamps a sensor unit containing devices that measure velocity or acceleration. Typically velocity or acceleration are measured along three orthogonal directions. Variations of this system include redundant measurements along 4 directions, or multiple measurements along one direction to increase the sensitivity of the measurement to weak signals.

One major inefficiency of the borehole seismic process is the need for each downhole multi-component receiver to be clamped to the borehole wall. Clamping devices use power and are relatively heavy and so this may limit the number of measuring points and therefore the total length of the tool. The clamping and unclamping process takes time. Clamping devices can also become stuck or jammed, increasing the risk of not being able to retrieve the tool from the borehole.

Free-hanging receiver arrays using only vertical geophones or free-hanging hydrophone strings with simple pressure transducers may be attractive choices; many receivers can be deployed with minimal effort, and considerable time is saved by avoiding repetitive clamping and unclamping. However, these receivers provide only single component data which limits subsurface imaging and seismic data extraction, because the azimuthal angle of incidence of the different waves in the data cannot be resolved. Additionally, even if the wavelengths of the waves are much larger than the diameter of the borehole not all the wavefields measured in the borehole are the same as those measured as in the formation. This is due to the fact that the pressure field and the displacement/velocity/acceleration component tangential to the borehole wall are not continuous between the fluid in the borehole and the formation (“Fluid and solid motion in the neighborhood of a fluid-filled borehole due to the passage of a low-frequency elastic plane wave”, Michael Schoenberg, GEOPHYSICS June 1986, Vol. 51, No. 6, pp. 1191-1205). Moreover, because the receivers are free-hanging, borehole waves are a major source of noise. Although some of this noise can be removed with various filtering operations, free-hanging sensors do not image as deep as their clamped-geophone counterparts.

Borehole streamers containing only hydrophones have been used to acquire both vertical seismic profiling (“VSP”) and cross-well seismic surveys (see for example, Wong et al., TLE, January 1987, 36-41; Marzetta et al., A Hydrophone Vertical Seismic Profiling Experiment, Geophysics, 1988, 53 (11) 1437-1444; Kragh et al., Anisotropic Traveltime Tomography in a Hard-Rock Environment, First Break, 1995, 14, 10, 391-397). Although these systems were designed for borehole environments they appear to have limited overall length (32 channels, 12 channels and 16 channels, respectively). The hydrophone spacing in these tools is a few meters, with the exception of Marzetta et al. (1988), which use a 1.5 m hydrophone spacing to avoid the tube wave noise, and 8 separate downhole positions to cover the aperture. These systems appear to not contain elastic wavefield measuring devices.

### SUMMARY OF THE INVENTION

The present disclosure provides a downhole seismic tool and method of seismic surveying.

The borehole seismic tool comprises a cable to be positioned within a borehole and at least one sensor for measuring seismic signals mounted on the cable, within the cable, or both, and providing measurements of particle motion perpendicular to an axis of the borehole.

In one embodiment, the at least one sensor providing measurements of particle motion perpendicular to the axis of the borehole is a 1C MEMS-based accelerometer.

In another embodiment the at least one sensor providing measurements of particle motion perpendicular to the axis of the borehole is a velocity sensor.

In some embodiments, the tool comprises two sensors providing measurements of 2-orthogonal particle motion perpendicular to the borehole axis. The sensors providing measurements of 2-orthogonal particle motion are 1C MEMS-based accelerometers or velocity sensors.

In some embodiments the tool comprises a set of sensors for measuring seismic signals densely arranged along the entire length of the cable.

In some embodiments, the tool comprises at least one additional sensor providing auxiliary measurements for orientation of the sensors providing measurements of particle motion perpendicular to the axis of the borehole.

In some embodiments, the tool comprises at least one additional sensor providing measurements of particle motion along the axis of the borehole and mounted on a section of the cable clamped to a borehole wall or a casing, sensor spacing is selected so as to attenuate residual tube waves.

In some embodiments, the method of seismic surveying comprises lowering a seismic tool into a borehole, wherein the tool comprises a cable and at least one sensor for measuring particle motion mounted on the cable, within the cable, or both, positioning the tool in the borehole, firing a seismic source generating a seismic wave and measuring particle motion associated with the passing seismic wave perpendicular to an axis of the borehole using the at least one sensor for measuring particle motion.

In some embodiments the method comprises clamping a section of the cable to a borehole wall or casing and measuring particle motion along the axis of the borehole using at least one sensor providing measurements of particle motion along and perpendicular to the axis of the borehole and mounted on the clamped section of the cable.

### BRIEF DESCRIPTION OF THE DRAWINGS

FIG. 1 is a schematic illustration of a stiff but flexible seismic tool in accordance with embodiments of the present invention,

FIG. 2 is a schematic illustration of a stiff but flexible seismic tool in accordance with embodiments of the present invention with sections of the tool clamped to a borehole wall or a casing,

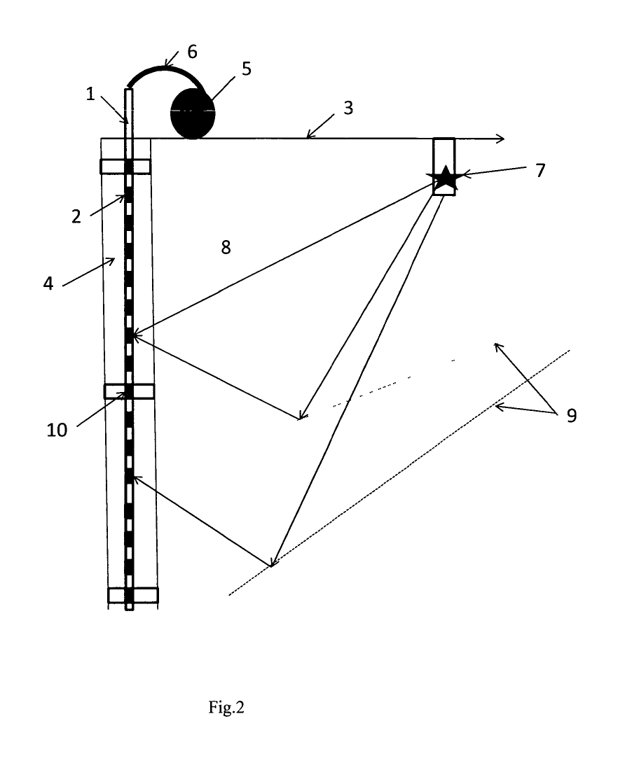

FIG. 3 is a close-up schematic illustration of a section of stiff but flexible seismic tool from FIG. 2.

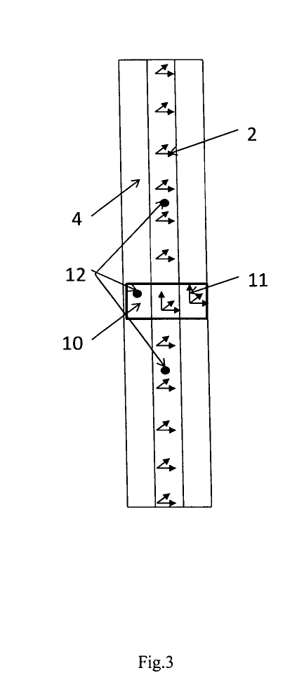

### DETAILED DESCRIPTION

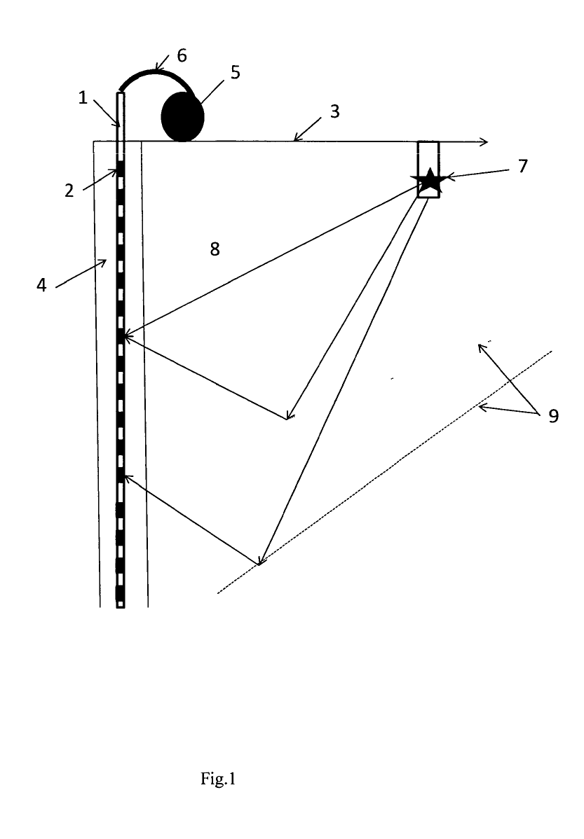

As it is shown on FIG. 1, a cable 1 carrying a plurality of particle motion sensors 2 is suspended from the surface 3 into the borehole 4. A cable reel 5 and feed 6 supports the cable 1 on the surface 3. Measurement signals or data are transmitted through the cable 1 to a base station (not shown) on the surface 3 for further processing. The cable 1 can be an armored cable as used for wireline operations with a plurality of wire strands running through its center.

In operation, a source 7 as shown is activated generating waves of seismic energies, which travel through the formation 8. Where the formation changes its impedance (as indicated by lines 9), part of the seismic energy is either reflected or refracted. The particle motion sensors 2 (which sense particle motion associated with a passing seismic wave) provide particle motion (velocity or acceleration) measurements perpendicular to the axis of the borehole; the sensors register movements of the earth and the measurements are transmitted directly or after in-line digitization and/or signal processing to the surface base station for storage, transmission and/or further processing. The subsequent data processing steps are known and well established in the field of hydrocarbon exploration and production.

The result is a tool that is much simpler, much faster to deploy, and much lighter than conventional tools requiring clamping.

In some embodiments, the cable 1 is up to several kilometers in length, for example from about 300 m to about 2 km, with embedded sensors and optional electronics. In some embodiments, the cable 1 is 1 km or greater in length. In some embodiments, the cable 1 is 100 m or less in length. For example, the cable 1 can be a reeled, spooled downhole cable, such as for example a stiff but flexible streamer. For the avoidance of doubt, the tool may be used in both shallow boreholes such as boreholes having a length of 100 m or less, and it may be used in deep boreholes, including boreholes having a length of up to several kilometers.

In some embodiments, the sensors providing measurements of particle motion perpendicular to the axis of the borehole are 1C MEMS-based accelerometers, which due to their low weight and size may be advantageous in achieving a thin tool almost like a continuous flexible armored cable in a small volume. In some embodiments, the sensors alternatively or in addition include any sensor capable of detecting a seismic signal which is compatible with configuring a thin flexible tool.

In some embodiments, the sensors providing measurements of particle motion perpendicular to the axis of the borehole are velocity sensors, such as moving coil geophones.

In some embodiments, the tool comprises two sensors providing measurements of 2-orthogonal particle motion (velocity or acceleration) perpendicular to the borehole axis.

In some embodiments, the tool comprises additional sensors providing auxiliary measurements for orientation of the sensors such as gyroscopes 12 which are devices for measuring orientation based on the principles of angular momentum.

In some embodiments, the tool comprises sensors 11 providing measurements of particle motion along and perpendicular to the axis of the borehole and mounted on a section of the cable clamped with clamps 10 to a borehole wall or a casing. It is proposed to clamp smaller and lighter sensor units, holding 1C motion sensors only and deployed with a smaller clamping force than in current systems (e.g. VSI). The smaller sensor units may be deployed more densely, with the denser spacing used to attenuate residual tube waves. The densely sampled 1C system may tolerate a higher level of tube wave at each station, as long as the subsequent array processing attenuates sufficiently the tube wave.

A number of embodiments have been described. Nevertheless it will be understood that various modifications may be made without departing from the spirit and scope of the invention.

1. A borehole seismic tool comprising:
a cable to be positioned within a borehole and at least one sensor for measuring seismic signals mounted on the cable, within the cable, or both, and providing measurements of particle motion perpendicular to an axis of the borehole.

2. The borehole seismic tool of claim 1 wherein the at least one sensor providing measurements of particle motion perpendicular to the axis of the borehole is an 1C MEMS-based accelerometer.

3. The borehole seismic tool of claim 1 wherein the at least one sensor providing measurements of particle motion perpendicular to the axis of the borehole is a velocity sensor.

4. The borehole seismic tool of claim 1 comprising at least two sensors providing measurements of 2-orthogonal particle motion perpendicular to the borehole axis.

5. The borehole seismic tool of claim 4 wherein the sensors providing measurements of 2-orthogonal particle motion perpendicular to the axis of the borehole are 1C MEMS-based accelerometer.

6. The borehole seismic tool of claim 4 wherein the sensors providing measurements of 2-orthogonal particle motion perpendicular to the axis of the borehole are velocity sensors.

7. The borehole seismic tool of claim 1 comprising a set of sensors for measuring seismic signals densely arranged along the entire length of the cable.

8. The borehole seismic tool of claim 1 further comprising at least one additional sensor providing auxiliary measurements for orientation of the sensors providing measurements of particle motion perpendicular to the axis of the borehole.

9. The borehole seismic tool of claim 8 wherein the at least one additional sensor providing auxiliary measurements is a gyroscope.

10. The borehole seismic tool of claim 1 further comprising at least one sensor providing measurements of particle motion along and perpendicular to the axis of the borehole and mounted on a section of the cable clamped to a borehole wall or a casing.

11. The borehole seismic tool of claim 10 comprising a set of sensors providing measurements of particle motion along and perpendicular to the axis of the borehole and mounted on a section of the cable clamped to a borehole wall or a casing, sensor spacing is selected so as to attenuate residual tube waves.

12. A method of acquiring seismic data downhole, comprising lowering a seismic tool into a borehole, wherein the tool comprises a cable and at least one sensor for measuring particle motion mounted on the cable, within the cable, or both, positioning the tool in the borehole, firing a seismic source generating a seismic wave and measuring particle motion associated with the passing seismic wave perpendicular to an axis of the borehole using the at least one sensor for measuring particle motion.

13. A method of claim 12, further comprising clamping a section of the cable to a borehole wall or casing and measuring particle motion along the axis of the borehole using at least one sensor providing measurements of particle motion along and perpendicular to the axis of the borehole and mounted on the clamped section of the cable.
